(19) United States
(12) Patent Application Publication
(10) Pub. No.: US 2024/0231911 A9
(43) Pub. Date: Jul. 11, 2024

(54) METHOD, ELECTRONIC DEVICE, AND COMPUTER PROGRAM PRODUCT FOR DETERMINING STORAGE RESOURCE USAGE AMOUNT

(71) Applicant: Dell Products L.P., Round Rock, TX (US)

(72) Inventor: Huijuan Fan, Chengdu (CN)

(21) Appl. No.: 18/066,242

(22) Filed: Dec. 14, 2022

(30) Foreign Application Priority Data
Oct. 24, 2022 (CN) 202211305568.5

(51) Int. Cl. G06F 9/50; G06F 18/26

(52) U.S. Cl. CPC G06F 9/5016; G06F 18/26

(57) ABSTRACT

Storage resource usage amount(s) are determined. For instance, storage resource usage data in a historical period related to a user is acquired. The pattern information of the storage resource usage data is determined according to a time series of the storage resource usage data, the time series being a series of observed values of the storage resource usage data in the historical period. In addition, the storage resource usage amount for a target period of the user can be determined based on the pattern information and the storage resource usage data. The pattern information at least includes at least one of a trend pattern, a cycle pattern, or an irregular pattern. Beneficially, a storage resource usage amount of a user can be more accurately determined in a future period, thereby providing the user with valuable reference information.

### RELATED APPLICATION

The present application claims the benefit of priority to Chinese Patent Application No. 202211305568.5, filed on Oct. 24, 2022, which application is hereby incorporated into the present application by reference herein in its entirety.

### TECHNICAL FIELD

Embodiments of the present disclosure relate to the field of computer science, and more particularly, to a method, an electronic device, and a computer program product for determining a storage resource usage amount.

### BACKGROUND

Cloud based data storage technologies have been welcomed by users in recent years because they can provide stable and secure data storage services for individuals and enterprises. Enterprises or individuals as users may acquire storage resources from data storage service providers, so that they can use data storage services at an agreed period without maintaining and operating businesses related to conventional data centers. Accordingly, in order to control costs related to data and data storage services, the users usually care about storage resource usage amounts already used and storage resource usage amounts that may be generated in the future. How to accurately estimate future storage resource usage amounts of users is an urgent problem to be solved.

### SUMMARY

Embodiments of the present disclosure provide a solution for determining a storage resource usage amount.

In a first example embodiment of the present disclosure, a method for determining a storage resource usage amount is provided. The method may include acquiring storage resource usage data in a historical period related to a user. The method may further include determining pattern information of the storage resource usage data according to a time series of the storage resource usage data, the time series being a series of observed values of the storage resource usage data in the historical period. In addition, the method may include determining the storage resource usage amount for a target period of the user based on the pattern information and the storage resource usage data. The pattern information at least includes at least one of a trend pattern, a cycle pattern, and an irregular pattern.

In a second example embodiment of the present disclosure, an electronic device is provided, including a processor; and a memory coupled to the processor and having instructions stored therein, where the instructions, when executed by the processor, cause the electronic device to perform actions including: acquiring storage resource usage data in a historical period related to a user; determining pattern information of the storage resource usage data according to a time series of the storage resource usage data, the time series being a series of observed values of the storage resource usage data in the historical period; and determining the storage resource usage amount for a target period of the user based on the pattern information and the storage resource usage data, wherein the pattern information at least includes at least one of a trend pattern, a cycle pattern, and an irregular pattern.

In a third example embodiment of the present disclosure, a computer program product is provided, wherein the computer program product is tangibly stored on a computer-readable medium and includes machine-executable instructions, wherein the machine-executable instructions, when executed, cause a machine to perform any steps of the method according to the first aspect.

This Summary part is provided to introduce the selection of concepts in a simplified form, which will be further described in the Detailed Description below. This Summary part is neither intended to identify key features or main features of the present disclosure, nor intended to limit the scope of the present disclosure.

### BRIEF DESCRIPTION OF THE DRAWINGS

Example embodiments of the present disclosure are described in more detail with reference to the accompanying drawings, the above and other objectives, features, and advantages of the present disclosure will become more apparent, and identical or similar reference numbers generally represent identical or similar components in the example embodiments of the present disclosure. In the accompanying drawings:

FIG. 1 illustrates a schematic diagram of an example environment according to an embodiment of the present disclosure;

FIG. 2 illustrates a flow chart of a process of determining a storage resource usage amount according to an embodiment of the present disclosure;

FIG. 3A to FIG. 3C respectively illustrate schematic diagrams of time series of a plurality of patterns according to an embodiment of the present disclosure;

FIG. 4 illustrates a schematic diagram of a system architecture for determining a storage resource usage amount according to an embodiment of the present disclosure; and

FIG. 5 illustrates a block diagram of an example device that can be used for implementing an embodiment of the present disclosure.

### DETAILED DESCRIPTION

The principles of the present disclosure will be described below with reference to several example embodiments illustrated in the accompanying drawings.

The term “include” and variants thereof used in this text indicate open-ended inclusion, that is, “including but not limited to.” Unless specifically stated, the term “or” means “and/or.” The term “based on” means “based at least in part on.” The terms “an example embodiment” and “an embodiment” indicate “a set of embodiments.” The term “another embodiment” indicates “a group of other embodiments.” The terms “first,” “second,” and the like may refer to different or identical objects. Other explicit and implicit definitions may also be included below.

As discussed above, a user will face a challenge when transferring workloads from a data center to a cloud based data storage. For example, when using a cloud based data storage service, a user usually needs to know a storage resource usage amount that will be generated, because unnecessary use or reservation higher than required will incur an additional cost. For example, if an actual storage resource usage amount of the user continues to exceed his/her reserved basic capacity, the additional capacity beyond the basic capacity will incur an additional cost. If the user can continuously manage the storage resource usage amount at a lower level, the cost may be saved. A conventional resource usage amount prediction solution usually focuses on a resource usage amount of a certain period or an average resource usage amount of a plurality of periods in historical data. However, there is usually a large difference between a result of such prediction and an actual storage resource usage amount, which cannot provide the user with a valuable reference.

In order to solve, at least in part, the above problem, an embodiment of the present disclosure provides a novel solution for determining a storage resource usage amount. First, historical data of a user may be classified. For example, in a time series of storage resource usage data in a historical period of the user, a category or pattern information of the storage resource usage data in a certain period of the time series may be identified, so that a change trend or function of storage resources in the period of the time series may be acquired. Then, a storage resource usage amount of the user in the next period may be predicted based on the category or pattern information. Through the above operations, a future storage resource usage amount may be predicted, and the future storage resource usage amount is determined by considering the change trend of the storage resource usage amount of the user, so that the estimated storage resource usage amount may be closer to the actual usage amount, thereby providing the user with a valuable reference and improving the user experience.

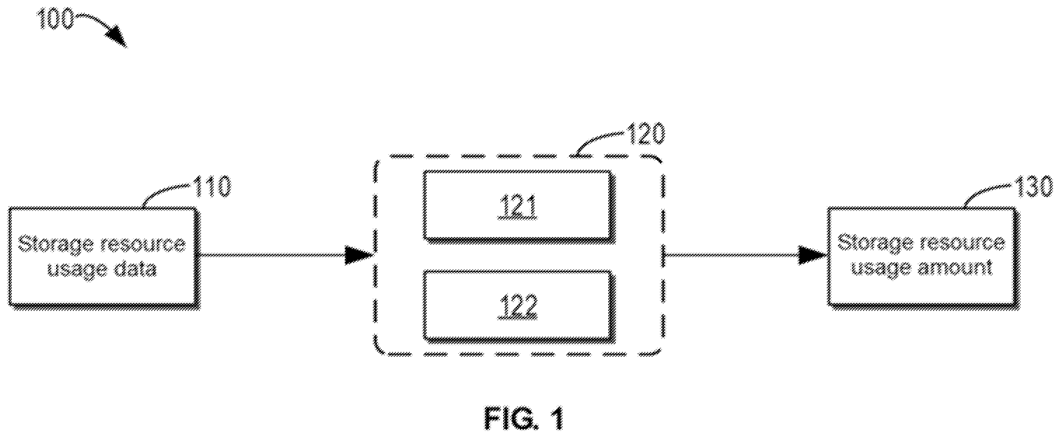

FIG. 1 illustrates a schematic diagram of example environment 100 according to an embodiment of the present disclosure. In example environment 100, a device and/or a process according to an embodiment of the present disclosure may be implemented. As shown in FIG. 1, example environment 100 may include storage resource usage data 110, computing device 120, and storage resource usage amount 130.

In FIG. 1, computing device 120 may be any device having a computing capacity arranged on a server side. As a non-limiting example, the computing device may be any type of a fixed computing device, a mobile computing device, or a portable computing device, including but not limited to a desktop computer, a laptop computer, a notebook computer, a netbook computer, a tablet computer, a smartphone, and the like. All or part of the components of the computing device may be distributed in a cloud. The computing device may also adopt a cloud-edge architecture. It should be understood that computing device 110 may be provided with a storage system, for example, a hard disk drive (HDD), a solid state disk (SSD), a removable disk, any other magnetic storage device and any other optical storage device, or any combination thereof.

Storage resource usage data 110 may usually be acquired from a historical log of the user, which usually represents a storage resource usage of the user in a certain historical period. As an example, the storage resource usage in the historical period may be regularly observed to form a series of observed values. Computing device 120 receives and analyzes storage resource usage data 110. Specifically, classification module 121 in computing device 120 is configured to classify input storage resource usage data 110 to determine the pattern information. For example, the pattern information may include a trend pattern, a cycle pattern, an irregular pattern, and the like. Then, prediction module 122 in computing device 120 is configured to determine a storage resource usage amount of a corresponding part of storage resource usage data in a future period based on the pattern information of the storage resource usage data of various parts. The future usage amount is determined based on the pattern information of the historical data, and therefore, the estimated future usage amount will be closer to the actual usage amount.

It is understandable that FIG. 1 is intended only to illustrate some concepts of the present disclosure and is not intended to limit the scope of the present disclosure.

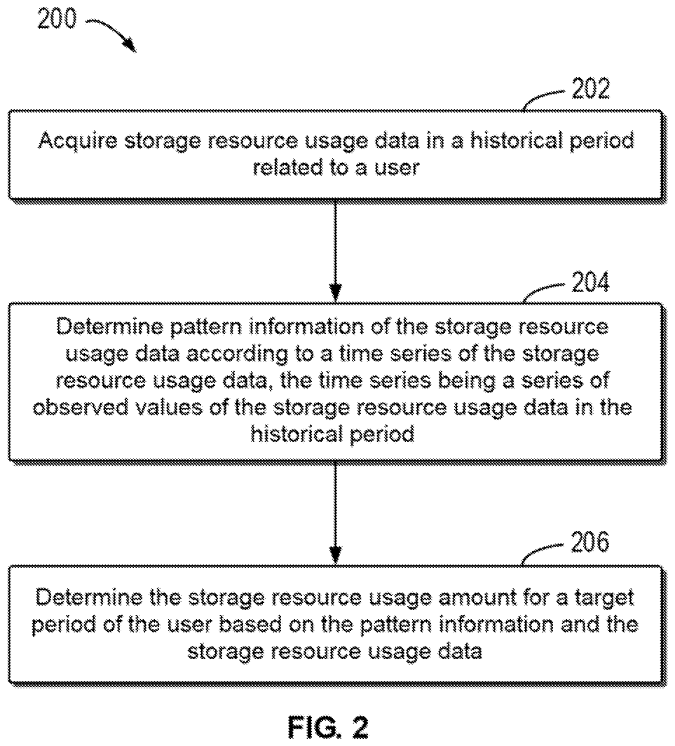

A process of determining a storage resource usage amount according to an embodiment of the present disclosure will be described in detail below with reference to FIG. 2. For ease of understanding, specific data mentioned in the following description is illustrative and is not intended to limit the protection scope of the present disclosure. It is understandable that embodiments described below may also include additional actions not shown and/or may omit actions shown, and the scope of the present disclosure is not limited in this regard.

FIG. 2 is a flow chart of process 200 of determining a storage resource usage amount according to an embodiment of the present disclosure. Process 200 for determining a storage resource usage amount according to the embodiment of the present disclosure is described now with reference to FIG. 2. For ease of understanding, specific examples mentioned in the following description are illustrative and are not intended to limit the protection scope of the present disclosure.

As shown in FIG. 2, in 202, computing device 120 may obtain storage resource usage data 110 in a historical period related to a user. As an example, computing device 120 may obtain a time series of the storage resource usage data in the historical period of the user.

At 204, computing device 120 may determine pattern information of the storage resource usage data according to the time series of storage resource usage data 110. It should be understood that the time series is a series of observed values of the storage resource usage data in the historical period. The pattern information may at least include at least one of a trend pattern, a cycle pattern, and an irregular pattern. The trend pattern is used for indicating that the time series of the observed values of the storage resource usage data in the historical period presents random fluctuations, but it may present a change trend for a long time, such as a linear change trend or a non-linear (exponential) change trend. The cycle pattern is used for indicating that the time series of the observed values of the storage resource usage data in the historical period presents periodic changes. The irregular pattern may indicate changes other than the trend pattern and the cycle pattern.

At 206, computing device 120 may determine storage resource usage amount 130 of a target period of the user based on the pattern information and storage resource usage data 110. In some embodiments, when determined storage resource usage amount 130 is greater than a predetermined threshold, a prompting message is sent to the user. It should be understood that a difference between the determination method of the storage resource usage amount in the present disclosure and the conventional method of direct prediction based on historical data is that the present disclosure creates a new parameter “pattern information” to classify storage resource usage data in different periods and different businesses in the historical data of the user, and to determine a future change trend of each category of storage resource usage data, and therefore, more accurate usage amount prediction may be made for each category of data. In this way, the present disclosure can more accurately determine the storage resource usage amount of the user in the future period, thus providing the user with valuable reference information.

It should be understood that the process of determining the pattern information is actually a process of classifying storage resource usage data 110. In some embodiments, computing device 120 may determine first data belonging to the trend pattern in storage resource usage data 110 by a least square method. The least square method is a standard method of regression analysis, which is mainly used for data fitting. The least square problem is mainly classified into two categories of linear or ordinary least squares and nonlinear least squares.

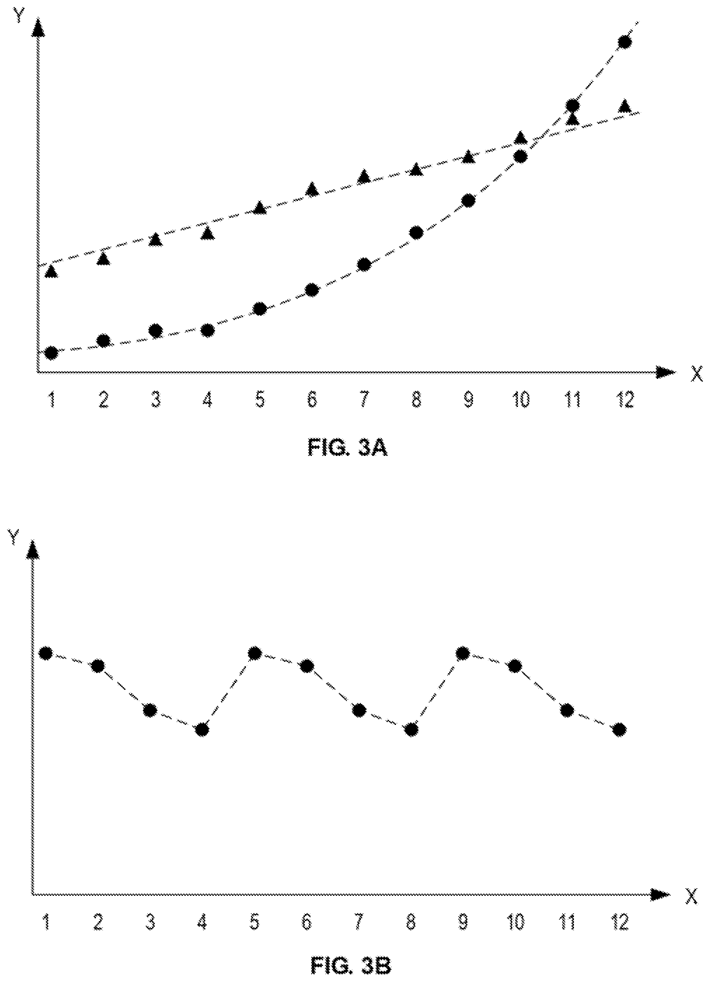

FIG. 3A illustrates a schematic diagram of a time series of the trend pattern according to an embodiment of the present disclosure. As shown in FIG. 3A, an abscissa X is used for indicating time, and its units may be hour, day, week, month, and the like, and an ordinate Y is used for indicating observed values of the storage resource usage amount. In FIG. 3A, a series of observed values composed of “▴” points may be determined as a linear trend pattern, while a series of observed values composed of “●” points may be determined as a nonlinear (exponential) trend pattern.

When it is determined that the storage resource usage data is in the trend pattern, in order to further determine storage resource usage amount 130, computing device 120 may determine, based on the trend pattern and the above first data, subsequent storage resource usage data on a time series of a subsequent period after the future target period, and determine an average of the subsequent storage resource usage data as a first part of storage resource usage amount 130.

As an example, computing device 120 may determine a function of the trend pattern of the first data. For example, a function of two data curves in FIG. 3A is determined by using the least square method. Later, if the “1st” to “5th” days in FIG. 3A are historical data, in order to estimate a storage resource usage amount of the “6th” day, storage resource usage amounts of the “6th” to “12th” days in the function of the trend pattern may be determined, and the storage resource usage amounts of the seven days may be averaged to determine the storage resource usage amount of the “6th” day.

In some embodiments, computing device 120 may determine second data belonging to the cycle pattern in storage resource usage data 110 by autocorrelation or discrete Fourier transform. FIG. 3B illustrates a schematic diagram of a time series of the cycle pattern according to an embodiment of the present disclosure. As shown in FIG. 3B, a series of observed values composed of “●” points may be determined as periodic changes, and therefore, it belongs to the cycle pattern.

When it is determined that the storage resource usage data is in the cycle pattern, in order to further determine storage resource usage amount 130, computing device 120 may determine the maximum storage resource usage data and the minimum storage resource usage data on the time series in the second data based on the cycle pattern, and determine an average of the maximum storage resource usage data and the minimum storage resource usage data as a second part of storage resource usage amount 130.

As an example, computing device 120 may determine one cycle of the second data, for example, the “1st” to “4th” days in FIG. 3B. To estimate a storage resource usage amount on the “6th” day, the maximum value (that is, the storage resource usage amount on the “1st” day) and minimum value (that is, the storage resource usage amount on the “4th” day) in the cycle may be determined, and an average of the maximum and minimum values may be determined as the storage resource usage amount on the “6th” day.

In some embodiments, computing device 120 may determine data other than the first data and the second data in storage resource usage data 110 as third data. FIG. 3C illustrates a schematic diagram of a time series of the irregular pattern according to an embodiment of the present disclosure. As shown in FIG. 3C, a series of observed values composed of “●” points may be determined as irregular changes, and therefore, it belongs to the irregular pattern.

When it is determined that the storage resource usage data is in the irregular pattern, in order to further determine storage resource usage amount 130, computing device 120 may determine at least part of storage resource usage data on a time series of the third data based on the irregular pattern, and determine an average of the at least part of storage resource usage data as a third part of storage resource usage amount 130.

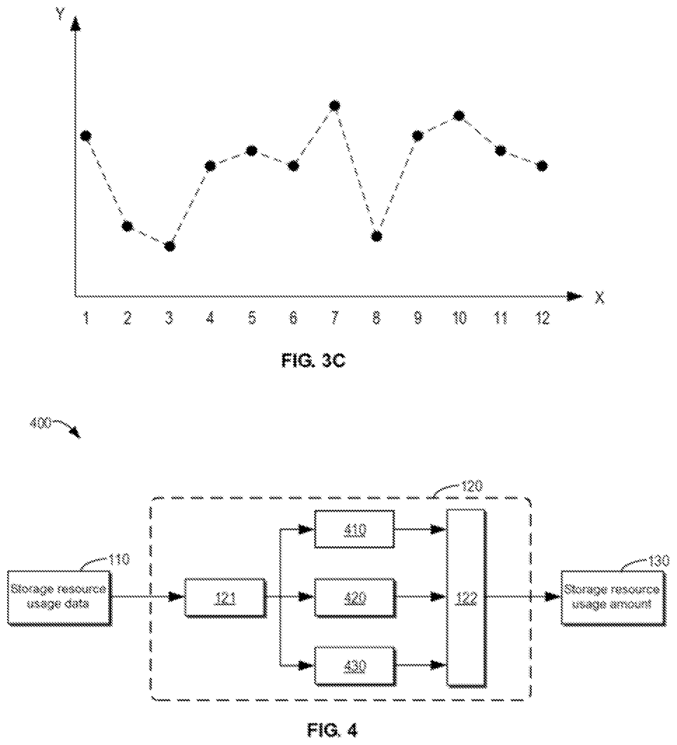

By means of the above description with reference to FIG. 3A to FIG. 3C, the present disclosure provides a process for classifying different types of storage resource usage data. An overall system architecture for determining a storage resource usage amount will be further described below with reference to FIG. 4. FIG. 4 illustrates a schematic diagram of system architecture 400 for determining a storage resource usage amount according to an embodiment of the present disclosure.

As shown in FIG. 4, after storage resource usage data 110 is input to computing device 120, it is first classified by classification module 121 in computing device 120 to obtain first data 410 conforming to the trend pattern, second data 420 conforming to the cycle pattern, and third data 430 conforming to the irregular pattern. Further, first data 410, second data 420, and third data 430 are input to prediction module 122 in computing device 120. Prediction module 122 determines storage resource usage amount 130 based on the trend pattern, the cycle pattern, the irregular pattern, and corresponding first data 410, second data 420, and third data 430, respectively. The above embodiment integrates the change trends of different categories of first data 410, second data 420, and third data 430; therefore, determined storage resource usage amount 130 may be more accurate than the conventional method of direct prediction based on historical data.

Through the above embodiment, the future storage resource usage amount may be accurately predicted by considering the change trend of the storage resource usage amount of the user, so that the estimated storage resource usage amount may be closer to the actual usage amount, thereby providing the user with a valuable reference.

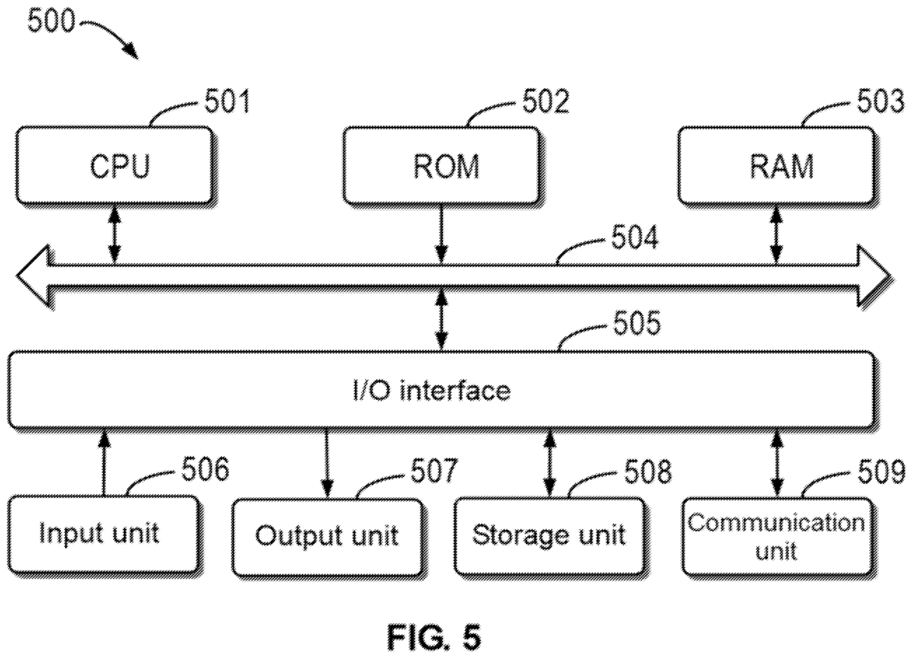

FIG. 5 illustrates a block diagram of example device 500 that may be used for implementing an embodiment of the present disclosure. For example, electronic device 500 may be used for implementing computing device 120 shown in FIG. 1. As shown in the figure, electronic device 500 includes central processing unit (CPU) 501 that can execute various appropriate actions and processing according to computer program instructions stored in read-only memory (ROM) 502 or computer program instructions loaded from storage unit 508 into random access memory (RAM) 503. Various programs and data required for operations of device 500 may also be stored in RAM 503. CPU 501, ROM 502, and RAM 503 are connected to each other through bus 504. Input/output (I/O) interface 505 is also connected to bus 504.

A plurality of components in device 500 are connected to I/O interface 505, including: input unit 506, such as a keyboard and a mouse; output unit 507, such as various types of displays and speakers; storage unit 508, such as a magnetic disk and an optical disc; and communication unit 509, such as a network card, a modem, and a wireless communication transceiver. Communication unit 509 allows device 500 to exchange information/data with other devices via a computer network, such as the Internet, and/or various telecommunication networks.

Processing unit 501 executes the various methods and processing described above, such as process 200. For example, in some embodiments, the various methods and processing described above may be implemented as computer software programs or computer program products, which are tangibly included in a machine-readable medium, such as storage unit 508. In some embodiments, part of or all the computer program may be loaded and/or installed to device 500 via ROM 502 and/or communication unit 509. When the computer programs are loaded into RAM 503 and executed by CPU 501, one or more steps of any process described above may be executed. Alternatively, in other embodiments, CPU 501 may be configured in any other suitable manners (for example, by means of firmware) to execute a process such as process 200.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electrical storage device, a magnetic storage device, an optical storage device, an electromagnetic storage device, a semiconductor storage device, any non-transitory storage device, or any appropriate combination described above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or a plurality of programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described here with reference to flow charts and/or block diagrams of the method, the apparatus (system), and the computer program product according to the embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or a plurality of blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flowcharts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or a plurality of executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flowcharts as well as a combination of blocks in the block diagrams and/or flowcharts may be implemented using a dedicated hardware-based system that executes specified functions or actions, or using a combination of special hardware and computer instructions.

Various implementations of the present disclosure have been described above. The foregoing description is illustrative rather than exhaustive, and is not limited to the disclosed implementations. Numerous modifications and alterations are apparent to persons of ordinary skill in the art without departing from the scope and spirit of the illustrated implementations. The selection of terms used herein is intended to best explain the principles and practical applications of the implementations or the improvements to technologies on the market, or to enable other persons of ordinary skill in the art to understand the implementations disclosed herein.

What is claimed is:

1. A method, comprising:
acquiring, by a system comprising a processor, storage resource usage data in a historical period related to a user;
determining pattern information of the storage resource usage data according to an observed time series of the storage resource usage data, the observed time series being a series of observed values of the storage resource usage data in the historical period; and
determining a storage resource usage amount for a target period of the user based on the pattern information and the storage resource usage data,
wherein the pattern information comprises at least one of a trend pattern, a cycle pattern, or an irregular pattern.

2. The method according to claim 1, wherein determining the pattern information comprises:
determining first data belonging to the trend pattern in the storage resource usage data by a least square process.

3. The method according to claim 2, wherein determining the storage resource usage amount comprises:
determining, based on the trend pattern and the first data, subsequent storage resource usage data on a subsequent time series of a subsequent period after the target period; and
determining an average of the subsequent storage resource usage data as a part of the storage resource usage amount.

4. The method according to claim 2, wherein determining the pattern information further comprises:
determining second data belonging to the cycle pattern in the storage resource usage data by autocorrelation or discrete Fourier transform.

5. The method according to claim 4, wherein determining the storage resource usage amount comprises:
determining maximum storage resource usage data and minimum storage resource usage data on a time series in the second data based on the cycle pattern; and
determining an average of the maximum storage resource usage data and the minimum storage resource usage data as a part of the storage resource usage amount.

6. The method according to claim 4, wherein determining the pattern information further comprises:
determining data other than the first data and the second data in the storage resource usage data as third data.

7. The method according to claim 6, wherein determining the storage resource usage amount comprises:
determining at least a part of the storage resource usage data on a time series of the third data based on the irregular pattern; and
determining an average of at least the part of the storage resource usage data as a part of the storage resource usage amount.

8. The method according to claim 1, further comprising:
sending a prompting message to the user in response to a determination that the storage resource usage amount is greater than a defined threshold.

9. A device, comprising:
a processor; and
a memory coupled to the processor and having instructions stored therein, wherein the instructions, when executed by the processor, cause the electronic device to perform actions comprising:
acquiring storage resource usage data in a historical period related to a user identity;
determining pattern information of the storage resource usage data according to a first time series of the storage resource usage data, the first time series being a series of observed values of the storage resource usage data in the historical period; and
determining a storage resource usage amount for a target period related to the user identity based on the pattern information and the storage resource usage data,
wherein the pattern information comprises at least one of a trend pattern, a cycle pattern, or an irregular pattern.

10. The device according to claim 9, wherein determining the pattern information comprises:
determining first data belonging to the trend pattern in the storage resource usage data by applying a least square function.

11. The device according to claim 10, wherein determining the storage resource usage amount comprises:
determining, based on the trend pattern and the first data, subsequent storage resource usage data on a second time series of a subsequent period after the target period; and
determining an average of the subsequent storage resource usage data as a part of the storage resource usage amount.

12. The device according to claim 10, wherein determining the pattern information further comprises:
determining second data belonging to the cycle pattern in the storage resource usage data by autocorrelation or discrete Fourier transform.

13. The device according to claim 12, wherein determining the storage resource usage amount comprises:
determining maximum storage resource usage data and minimum storage resource usage data on a time series in the second data based on the cycle pattern; and
determining an average of the maximum storage resource usage data and the minimum storage resource usage data as a part of the storage resource usage amount.

14. The device according to claim 12, wherein determining the pattern information further comprises:
determining data other than the first data and the second data in the storage resource usage data as third data.

15. The device according to claim 14, wherein determining the storage resource usage amount comprises:
determining at least a part of the storage resource usage data on a second time series of the third data based on the irregular pattern; and
determining an average of at least the part of the storage resource usage data as a part of the storage resource usage amount.

16. The device according to claim 9, wherein the device is a first device, and wherein the actions further comprise:
sending a prompting message to a second device associated with the user identity in response to a determination that the storage resource usage amount is greater than a predetermined threshold.

17. A computer program product that is stored on a non-transitory computer-readable medium and comprises machine-executable instructions, wherein the machine-executable instructions, when executed, cause a machine to perform operations, comprising:
acquiring storage resource usage data in a historical period associated with a user identity representative of a user;
determining pattern information of the storage resource usage data according to a time series of the storage resource usage data, the time series being a series of observed values of the storage resource usage data in the historical period; and
determining a storage resource usage amount for a target period associated with the user identity based on the pattern information and the storage resource usage data, wherein the pattern information comprises at least one of the patterns from a group of patterns, the group comprising a trend pattern, a cycle pattern, and an irregular pattern.

18. The computer program product according to claim 17, wherein determining the pattern information comprises:
determining first data belonging to the trend pattern in the storage resource usage data by applying a least square function.

19. The computer program product according to claim 18, wherein the time series is a first time series, and wherein determining the storage resource usage amount comprises:
determining, based on the trend pattern and the first data, subsequent storage resource usage data on a second time series of a subsequent period after the target period; and
determining an average of the subsequent storage resource usage data as a part of the storage resource usage amount.

20. The computer program product of claim 18, wherein the operations further comprise:
sending a prompting message to a device associated with the user identity in response to a determination that the storage resource usage amount is greater than a defined threshold.
